(19) United States
(12) Patent Application Publication
(10) Pub. No.: US 2026/0181745 A1
(43) Pub. Date: Jun. 25, 2026

(54) HEATING ELEMENT AND FLUID HEATER AND METHOD FOR HEATING FLUID

(71) Applicant: KANTHAL AB, Hallstahammar (SE)

(72) Inventors: Thomas LEWIN, Hallstahammar (SE); Pengcheng CAO, Hallstahammar (SE)

(73) Assignee: KANTHAL AB, Hallstahammar (SE)

(21) Appl. No.: 19/125,329

(22) PCT Filed: Nov. 14, 2023
(86) PCT No.: PCT/EP2023/081804

§ 371 Date: Apr. 29, 2025

(30) Foreign Application Priority Data
Nov. 17, 2022 (EP) 22208183.8

(51) Int. Cl. H05B 3/24

(52) U.S. Cl. CPC H05B 3/24; H05B 2203/007; H05B 2203/017

(57) ABSTRACT

A heating element comprising first, second, and third regions, and at least three fluid permeable heating panels. The heating element has a 3-dimensional shape which is delimited in part by first and second lateral sides the heating panels extending between the sides. Each of the first, second, and third region is configured to form one phase of a 3-phase electrical load, and wherein either a common electrical conductor connects the first, second, and third regions, to form a star configuration, or first, second, and third electrical conductors each connects two of the first region, the second region, and the third region to form a delta configuration.

### TECHNICAL FIELD

The invention relates to a heating element for an electric fluid heater and to an electric fluid heater. The invention also relates to a method for heating a fluid in an electric fluid heater.

### BACKGROUND

Electric heaters may include one or more electrical resistance heating elements arranged for heating a fluid passing through the heater. Conventionally, relatively thin wires, strips or tubes used as the heating elements with the heating effect achieved by the passage of electric current through the respective wires, strips, and tubes.

One kind of electric heater comprises one or more electrically heated channel forming elements for heating a fluid. For instance, WO 2009/071590, EP 2784049, and US 2007/0189741 disclose such heating systems comprising ceramic electric resistance heating elements forming one or more channels, through which a fluid to be heated flows. A current source is connected directly to the relevant electric resistance heating element.

In EP 2784049, the heating system comprises more than one channel forming element which are electrically connected in parallel. Similarly, in the heating system of US 2007/0189741 more than one channel forming elements are electrically connected in parallel while also some of the channel forming elements are connected in series.

Irrespective of the electrical connection of the channel forming heating elements in the systems of WO 2009/071590, EP 2784049, and US 2007/0189741, the individual channel forming heating elements extend along a flow path of the fluid to be heated. That is, the individual channels of the heating elements, through which the fluid to be heated flows, are arranged in parallel along the entire length, over which the fluid is heated.

According to the same principle of fluid flowing through channels, in a completely different kind of heating system, US 2022/132633 discloses a system that includes a firebrick checkerwork that includes conductive firebrick layers, each including a plurality of electrically conductive doped metal oxide firebricks with one or more airflow vents.

U.S. Pat. No. 3,244,860 discloses a heater for gas comprising a metal mesh electrical resistance heating element arranged in a casing. A number of concentrically arranged individual mesh strips of hexagonal cross section form the heating element. The individual mesh strips are electrically connected in parallel. A gas flows through the casing and radially inwardly through the mesh strips and is thus, heated.

In contrast with the heating systems of WO 2009/071590, EP 2784049, and US 2007/0189741, in the system of U.S. Pat. No. 3,244,860 the mesh strips are arranged such that the gas flows in sequence, i.e., in series, through the respective mesh strips.

WO 2021/083947 discloses a heating element comprising a main body having a three-dimensional matrix with an open structure including openings and internal voids, cavities and/or pores extending throughout the main body. The three-dimensional matrix is provided as a lattice having a repeating unit cell extending in three directions. The electrical connection of the main body is not discussed in any detail.

DE 102009031890 and DE 102005012731 disclose different kinds of electrical resistance heating elements.

### SUMMARY

There still exists a need for effective and efficient electric heaters for heating fluid.

Thus, it would be advantageous to achieve an efficient electric fluid heater. In particular, it would be desirable to enable a compact electric heater of uncomplicated construction providing an even power load during its use. To better address one or more of these concerns, at least one of a heating element for an electric fluid heater, an electric fluid heater, and a method for heating a fluid in an electric fluid heater as defined in the independent claims is provided.

According to an aspect, there is provided a heating element for an electric fluid heater, the heating element having an extension along a first axis and comprising a first region, a second region, and a third region, and at least three fluid permeable heating panels. Each of the at least three fluid permeable heating panels comprises a 3-dimensional structure, the 3-dimensional structure comprising a multitude of members of at least one electrically conductive material. Within the 3-dimensional structure, the members are connected to each other at nodes. The heating element has a 3-dimensional shape which is delimited in part by a first lateral side and an opposite second lateral side, the first and second lateral sides extending substantially in parallel with the first axis and the fluid permeable heating panels extending between the first and second lateral sides. The first region comprises a first fluid permeable heating panel of the at least three fluid permeable heating panels, the second region comprises a second fluid permeable heating panel of the at least three fluid permeable heating panels, and the third region comprises a third fluid permeable heating panel of the at least three fluid permeable heating panels, wherein each of the first, second, and third region is configured to form one phase of a 3-phase electrical load, and wherein
either a common electrical conductor connects the first, second, and third regions,
or a first electrical conductor, a second electrical conductor, and a third electrical conductor each connects two of the first region, the second region, and the third region.

Since the heating element comprises the at least three fluid permeable heating panels of the 3-dimensional structure comprising a multitude of members of at least one electrically conductive material and the heating element being delimited by the first and second lateral sides, between which the fluid permeable heating panels extend—the heating element has a compact structure which provides for a high energy transfer in a format that is easily incorporated in an electric fluid heater. Moreover, since the heating element comprises at least the first, second, and third regions and each of the first, second, and third region is configured to form one phase of a 3-phase electrical load, and since
either the common electrical conductor connects the first, second, and third regions,
or the first, second, and third electrical conductor each connects two of the first, second, and third regions—the heating element is configured for each of the first, second, and third regions to be connected to one of three phases of an alternating current (AC) mains electrical power supply without requiring separate electrical wiring between the first, second, and third regions. Put differently, the connections between the regions of the 3-phase load formed by the regions of the heating element are built-in in the heating element. Also this contributes to the compactness and uncomplicated character of the heating element. Furthermore, as stated, the arrangement of the first, second, and third regions is configured for connection to three phases of an alternating current (AC) mains electrical power supply and thus, provides an even electrical load over the three phases. Accordingly, the mains electrical power supply at the facility where the heating element is operating is evenly loaded and peak load is reduced in comparison with a heating element of the same power rating connected to only one of the phases of the mains electrical power.

According to a further aspect, there is provided an electric fluid heater comprising a housing having a fluid inlet and a fluid outlet, wherein a fluid flow path for the fluid to be heated is defined within the housing, and wherein at least one heating element according to any one of aspects and/or embodiments discussed herein is arranged along at least part of the fluid flow path.

Since the electric fluid heater comprises at least one heating element according to any one of aspects and/or embodiments discussed herein, a compact and efficient electric fluid heater that forms an even electrical load over three phases of mains electrical power is provided.

According to a further aspect, there is provided a method for heating a fluid in an electric fluid heater according to any one of aspects and/or embodiments discussed herein comprising steps of:
supplying a fluid to the fluid inlet,
supplying a three-phase electric current to the at least one heating element in order to heat the fluid permeable heating panels,
conducting the fluid along the fluid flow path through the fluid permeable heating panels to the fluid outlet, and
leading the fluid from the fluid outlet.

Since the method is performed utilising an electric fluid heater according to any one of aspects and/or embodiments discussed herein, a method for efficiently heating a fluid that constitutes an even electrical load over three phases of mains electrical power is provided.

Turning to the heating element, according to the first alternative, via the common electrical conductor, the regions are arranged in an electrical Y configuration or Y topology, more generally referred to as star topology or star transform or star configuration. According to the second alternative, via the first, second, and third electrical conductors, the regions are arranged in an electrical delta (Δ) configuration or delta topology, more generally referred to as partial mesh configuration or partial mesh topology.

The heating element is configured for connection to three-phase alternating current AC mains electrical power, each of the three regions comprising at least one of the heating panels being connected to one phase of the mains electrical power.

Each of the regions is configured to form one phase of the 3-phase electrical load by being connectable at least one end of each region to AC mains power, e.g. via a terminal. Such a terminal is provided for making an electrical connection and may be a dedicated connection member or may form part of a member of the heating element, such as of each of the first, second, and third electrical conductors.

Accordingly, the heating element may comprise three terminals for connecting electric power to the heating element. One terminal may be connected to each region.

For instance, according to the first alternative of the heating element comprising the common electrical conductor connected to the three regions, one terminal may be provided for each region at an end thereof opposite to the common electrical conductor. According to the second alternative of the heating element comprising the first, second, and third electrical conductors, one terminal may be formed as part of each of the first, second, and third electrical conductors.

According to some embodiments, the common electrical conductor may be connected to electrical neutral or to electrical ground. According to other embodiments, the common electrical conductor is neither connected to electrical neutral nor to electrical ground.

As mentioned above, the heating element has a 3-dimensional shape which is delimited in part by a first lateral side and an opposite second lateral side. Accordingly, the heating element may have a generally substantially cylindrical, cube, rectangular cuboid, prism, or parallelepiped shape.

The first and second lateral sides as well as further sides of the heating element form sides of the 3-dimensional shape. The heating element may be more or less open from these sides. Put differently, these sides may not necessarily be formed by continuous wall elements. Continuous wall elements may not be required in the heating element as such since a fluid flow path for the fluid to be heated may be defined within a housing, in which the heating element is arranged. The housing may be e.g., a housing of an electric fluid heater or a housing formed by a portion of a conduit, through which a fluid to be heated flows.

The first and second lateral sides extending substantially in parallel with the first axis give the heating element a 3-dimensional shape that can be easily arranged in a housing of an electric fluid heater. This may also contribute to a substantially constant cross-sectional area perpendicularly to the first axis throughout the heating element and/or along the fluid flow path.

Herein, the fluid permeable heating panels alternatively may be referred to as heating panels.

Each of the at least three fluid permeable heating panels may extend between the first and second lateral sides.

Each region may comprise more than one fluid permeable heating panel.

The fluid permeable heating panels of the heating element may be arranged along one or more rows, the rows extending in parallel with the first axis. For instance, the fluid permeable heating panels of each region may be arranged along one or more rows.

There is an interspace between adjacent fluid permeable heating panels within one row of fluid permeable heating panels and between adjacent fluid permeable heating panels of adjacent rows of fluid permeable heating panels. The fluid permeable heating panels of each row of fluid permeable heating panels extend between the first and second lateral sides of the heating element where the fluid permeable heating panels are electrically connected via electrical connectors.

It is noted that herein, for the sake of clarity, the term electrical conductor is used for an element that electrically connects at least two of the regions with each other and the term electrical connector is used for an element that electrically connects two fluid permeable heating panels within a region. In practice, an electrical conductor and an electrical connector may be elements of the same or similar kind.

According to some embodiments, a length of the heating element along the first axis may be longer than a maximum width of the heating element between the first and second lateral sides.

The 3-dimensional structure comprising a multitude of members provides for the fluid permeability of each fluid permeable heating panel. That is, between the multitude of members a multitude of voids are present, through which fluid can penetrate the fluid permeable heating panel.

The 3-dimensional structure is a self-supporting structure.

The fluid permeable heating panels may have any suitable shape as long as they can be arranged adjacent to each other along the first axis with an interspace between adjacent fluid permeable heating panels. For instance, seen in a view along to the first axis, the fluid permeable heating panels may have a round, an oval, a square, a rectangular, or a hexagonal shape. Seen in a side view, perpendicularly to the first axis, each fluid permeable heating panel may have e.g., a rectangular shape, a parallelogram shape, an S-shape, a C-shape, a V-shape, or a rhomboid shape.

Each fluid permeable heating panel may have an extension perpendicularly to the first axis, e.g., along a direction extending between the first and second lateral sides, which is longer than the extension of the fluid permeable heating panel along the first axis.

Along the first axis, one or more of the fluid permeable heating panels may differ from each other.

A thickness of each fluid permeable heating panel in parallel with the first axis may vary between different portions of one or more of the fluid permeable heating panels.

In a fluid permeable heating panel having a rectangular or parallelepiped shape seen in a view perpendicularly to the first axis, the angle at which the fluid permeable heating panel extends to the first axis is directly apparent.

In a fluid permeable heating panel having a shape that is curved or angled and/or a thickness that varies seen in a view perpendicularly to the first axis, the angle at which the fluid permeable heating panel extends to the first axis is an angle of a centre line of the fluid permeable heating panel i.e., the centre line as seen in the view perpendicularly to the first axis. Depending on the shape of the fluid permeable heating panel, the centre line may be straight or may change direction.

The heating element may comprise more than 10 fluid permeable heating panels, or more than 50 fluid permeable heating panels, or more than 100 fluid permeable heating panels.

The number of fluid permeable heating panels may depend inter alia on the thickness of the individual fluid permeable heating panels, the total energy transfer to be transferred by the heating element, the voltage to be connected to the heating element, the increase of temperature to be achieved in the heating element, the flow of fluid though the heating element, desired electric resistance, and desired heat transfer performance, etc.

The 3-dimensional structure of each of the fluid permeable heating panels may comprise at least three members arranged after each other along the first axis and connected to each other at nodes.

This means that along the first axis, each fluid permeable heating panel has an extension of at least three members. The three members may be arranged at an angle to the first axis. Accordingly, the length of the fluid permeable heating panel along the first axis may be shorter than the total length of three members.

Within the 3-dimensional structure, the members are connected to each other at nodes. A node may be defined by forming a connection point between at least three members and/or a connection point between two members with an abrupt directional change between the members.

The members of the 3-dimensional structure may be arranged more or less regularly within the structure. In a regular arrangement of the members in the 3-dimensional structure, the arrangement of the members is repeated at regular intervals.

The 3-dimensional structure may form a latticework body with a regularly repeating structure of members and nodes. The latticework body forms an open structure i.e., a fluid permeable structure.

The 3-dimensional structure may be advantageous as it can be formed into any shape and configuration. This may be achieved as it is lightweight and strong and may be manufactured by techniques such as additive manufacturing, etc. Due to the open structure of the 3-dimensional structure, the fluid flow to be heated is capable of passing through the heating element.

A further advantage of the 3-dimensional structure may be the availability and freedom of choice to design fluid flow path/s through the structure. For instance, a relatively dense structure may provide a higher fluid flow resistance than a less dense structure.

According to embodiments, the 3-dimensional structure comprises voids between the members, the voids permitting the fluid to pass through the fluid permeable heating panel, and wherein a void to member volume ratio of the 3-dimensional structure may be within a range of 1:1 to 10000:2. In this manner, an efficient energy transfer may be provided by the heating elements.

According to embodiments, the members may be connected at the nodes to form a multitude of unit cells. In this manner, the 3-dimensional structure may be provided in an efficient and repeatable manner e.g., suited for being produced in an additive manufacturing process.

Accordingly, the smallest repeating structure of the 3-dimensional structure may be a unit cell. The members of a unit cell may be referred to as struts.

As such, within the 3-dimensional structure a first unit cell may share members and nodes with an adjacent second unit cell. That is, struts and nodes bordering between first and second unit cells may be seen to form part of each of the first and second unit cells.

In the 3-dimensional structure, the regularly repeating structure may extend in three directions, a first, a second, and a third direction. One of these directions may coincide with the first axis. Alternatively, none of these directions coincides with the first axis.

In case of the 3-dimensional structure being formed by unit cells, the unit cells are arranged adjacent to each other in three directions. The three directions may extend at the same angle to each other. That is, the angle between the first and second directions may equal the angle between the second and third directions and the angle between the first and third directions. For instance, the angle between the directions may be 90 degrees or 60 degrees.

The 3-dimensional structure being formed by unit cells may be advantageous to withstand the thermal, physical and mechanical demands within the heating element.

The two or more fluid permeable heating panels within each region may be electrically connected in series via electrical connectors arranged at the first and second lateral sides. In such embodiments, each region may comprise the same number and kind of fluid permeable heating panels in order to provide an even electrical load between the regions.

According to embodiments, each of the at least three fluid permeable heating panels may be a result of an additive manufacturing process. In this manner, the heating panels may be efficiently manufactured.

According to embodiments, the common electrical conductor or each of the first, second, and third electrical conductors may be a result of an additive manufacturing process. In this manner, the electrical conductor or conductors may be efficiently manufactured e.g., in a same manufacturing process as heating panels.

According to embodiments, the first region may comprise one or more additional first fluid permeable heating panels of the at least three fluid permeable heating panels, wherein the first fluid permeable heating panels and the one or more additional first fluid permeable heating panels may be electrically connected in series via one or more electrical connectors arranged at the first and/or second lateral side. The second region may comprise one or more additional second fluid permeable heating panels of the at least three fluid permeable heating panels, wherein the second fluid permeable heating panel and the one or more additional second fluid permeable heating panels may be electrically connected in series via one or more electrical connectors arranged at the first and/or second lateral side. The third region may comprise one or more additional third fluid permeable heating panels of the at least three fluid permeable heating panels, wherein the third fluid permeable heating panel and the one or more additional third fluid permeable heating panels may be electrically connected in series via one or more electrical connectors arranged at the first and/or second lateral side. In this manner, electrically connecting the fluid permeable heating panels in series within a region may provide for flexibility in achieving desired electric resistance values in the heating element.

Serially connecting a smaller or larger number of the fluid permeable heating panels within each region provides lower or higher resistance values. The number of panels and accordingly, the total resistance value of each region of the heating element may be selected e.g., such that the heating element can be heated to desired lower or higher temperatures by passing an electric current through the serially connected fluid permeable heating panels within each region. Further, a design power rating, an electrical supply capability, a particular surface loading, etc. may be met by connecting a suitable number of fluid permeable heating panels in series within each region.

Within each region such electrical connection in series via electrical connectors may be between adjacent fluid permeable heating panels within a row of fluid permeable heating panels and/or between adjacent fluid permeable heating panels of adjacent rows of fluid permeable heating panels.

Thus, an electrically conductive path may be formed through the fluid permeable heating panels of each region of the heating element. The electrically conductive path may meander in one or more directions relative to the first axis. If a relevant region comprises only one row of fluid permeable heating panels, the electrically conductive path may meander in only one direction relative the first axis. If a relevant region comprises two or more rows of heating panels, the electrically conductive path may meander in two directions relative the first axis.

Within each region, the heating panels may be of the same kind. For instance, the first fluid permeable heating panel and the one or more additional first fluid permeable heating panels of the first region may all be of the same kind.

Alternatively, within each region, the heating panels may be of two or more different kinds.

According to embodiments, the heating element may comprise at least two rows of fluid permeable heating panels arranged adjacent to each other along the first axis. In this manner, the fluid permeable heating panels may be arranged in a compact manner within the heating element.

Each of the at least two rows of fluid permeable heating panels may comprise fluid permeable heating panels of at least one of the first, second, and/or third region.

Within at least part of the at least two rows of heating panels, the heating panels may be electrically connected in series via the electrical connectors. In order to achieve such connection in series, some of the electrical connectors may extend between adjacent fluid permeable heating panels within a row of fluid permeable heating panels. Additionally, some of the electrical connectors may extend between fluid permeable heating panels of adjacent rows of fluid permeable heating panels.

According to embodiments, each of the at least two rows of fluid permeable heating panels may comprise at least 2 fluid permeable heating panels.

According to some embodiments, each of the at least two rows of fluid permeable heating panels may comprise within a range of 4-20 fluid permeable heating panels or within a range of 4-50 fluid permeable heating panels.

According to embodiments, the first fluid permeable heating panel and the one or more additional first fluid permeable heating panels of the first region may be arranged in a first row of the at least two rows of fluid permeable heating panels and the second fluid permeable heating panel and the one or more additional second fluid permeable heating panels of the second region may be arranged in a second row of the at least two rows of fluid permeable heating panels. In this manner, the heating panels of the first and second regions may be arranged within the heating element.

The third fluid permeable heating panel and the one or more additional third fluid permeable heating panels of the third region may be arranged in the first and second rows of fluid permeable heating panels. Alternatively, the third fluid permeable heating panel and the one or more additional third fluid permeable heating panels of the third region may be arranged in a third row of heating panels.

According to embodiments the heating element may comprise electrically non-conductive spacer elements arranged at the first and second lateral sides between adjacent fluid permeable heating panels. In this manner, it may be ensured that individual heating panels do not short circuit within the heating element. Also, a stability of the heating element may be improved by the provision of the spacer elements.

According to embodiments wherein the heating element comprises at least two rows of heating panels, the heating element may comprise at least one electrically non-conductive further spacer element arranged between fluid permeable heating panels of adjacent rows of fluid permeable heating panels of the at least two rows of fluid permeable heating panels. In this manner, it may be ensured that individual heating panels do not short circuit between rows of heating panels within the heating element. Also, a stability of the heating element may be improved by the provision of the further spacer elements.

During use of the electric fluid heater, the fluid to be heated passes through at least one heating element and is heated therein. That is, the fluid the be heated enters the electric fluid heater, passes therethrough, and leaves the electric fluid heater at an elevated temperature. For instance, this may be done in accordance with the herein discussed method.

The electric fluid heater may be utilised for heating a fluid flow in any industrial or domestic apparatus or process. The fluid may be a gas, such as air. Thus, the electric fluid heater may be for heating a gas flow. The fluid may be a liquid. Thus, the electric fluid heater may be for heating a liquid flow or for heating a vapour.

The heating element may be arranged within the housing of the electric fluid heater such that the heating element fills the fluid flow path, at least in a direction perpendicularly to the first axis. Thus, the entire fluid flow may pass through the heating element along the first axis.

The electric fluid heater may comprise more than one heating element of same or different kinds arranged with its respective first axis arranged along the flow path. The heating elements may for instance differ with respect to the temperature to which they are electrically heated, the electrically conductive material of the heating panels, the number of heating panels, the length of the heating elements along their respective first axes, the 3-dimensional structure of the heating panels, etc.

The more than one heating elements may be arranged one after the other along the flow path, and/or the more than one heating elements may be arranged in parallel along the flow path.

In the fluid heater, the more than one heating elements may be electrically connected in series and/or electrically connected in parallel.

Further features of, and advantages with, the invention will become apparent when studying the appended claims and the following detailed description.

### BRIEF DESCRIPTION OF THE DRAWINGS

Various aspects and/or embodiments of the invention, including its particular features and advantages, will be readily understood from the example embodiments discussed in the following detailed description and the accompanying drawings, in which:

FIGS. 1a-1c illustrate heating elements according to embodiments,

FIGS. 2a-2d illustrate the heating element according to FIG. 1a in more detail,

FIGS. 3a-3d illustrate the heating element according to FIG. 1b in more detail,

FIG. 4 illustrates a method for heating a fluid in an electric fluid heater,

FIGS. 5a)-5c) schematically illustrate unit cells and their arrangement in a heating panel,

FIGS. 6a-6d illustrate a heating element according to embodiments,

FIGS. 7a-7c illustrate a heating element according to embodiments, and

FIGS. 8a-8c schematically illustrates a fluid heater according to embodiments.

### DETAILED DESCRIPTION

Aspects and/or embodiments of the invention will now be described more fully. Like numbers refer to like elements throughout. Well-known functions or constructions will not necessarily be described in detail for brevity and/or clarity.

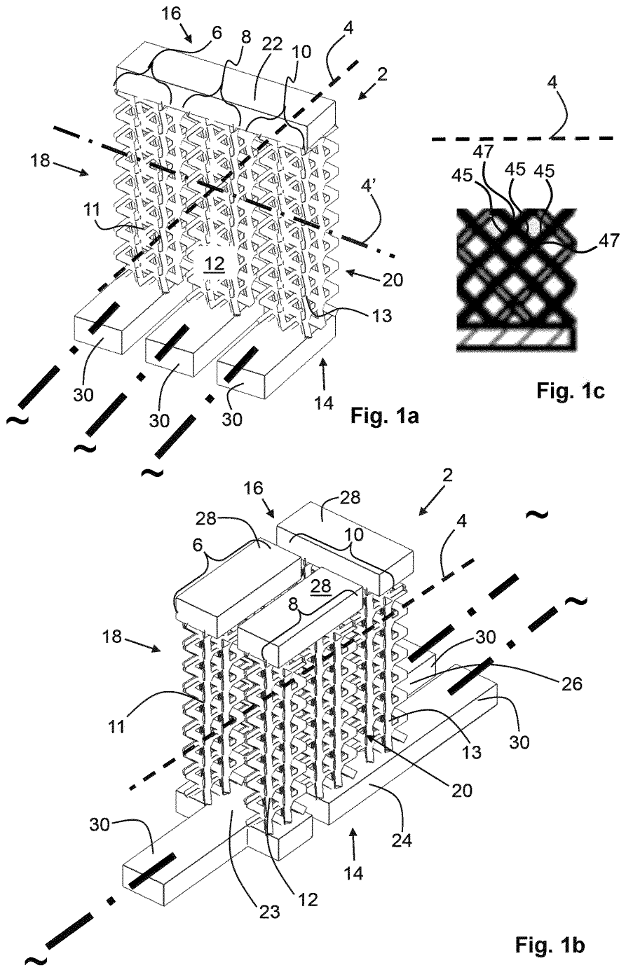

FIGS. 1a-1c illustrate heating elements 2 according to embodiments. In FIG. 1a, first embodiments of a heating element 2 are shown in an isometric view. In FIG. 1b, second embodiments of a heating element 2 are shown in an isometric view. FIG. 1c shows a portion of a 3-dimensional structure of the heating elements 2 of FIGS. 1a and 1b.

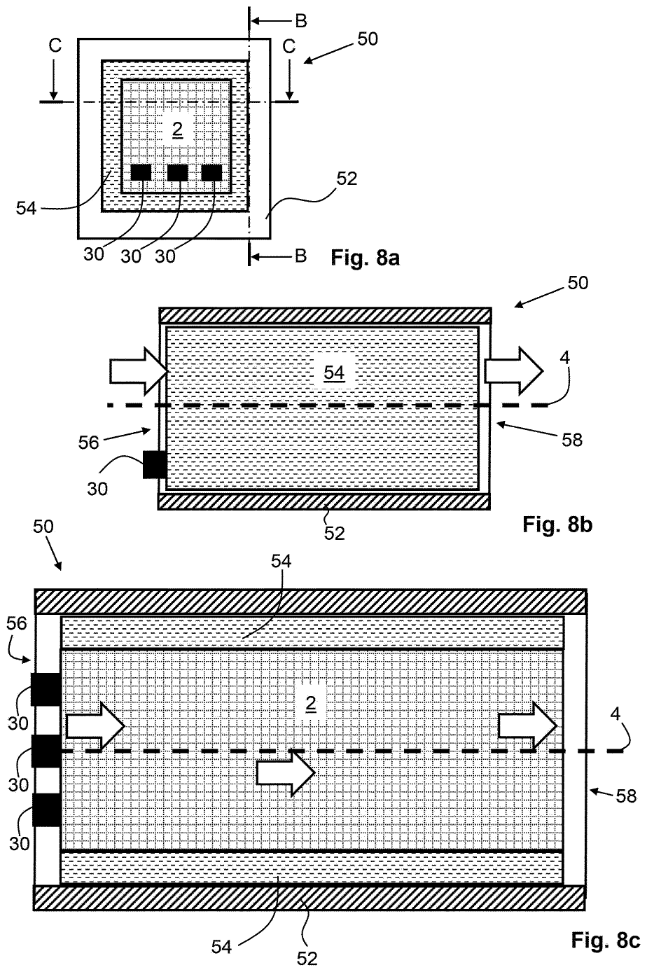

The heating element 2 is configured for use in an electric fluid heater. In the electric fluid heater, a fluid flow path is delimited such that the fluid to be heated flows through the heating element 2. See further below e.g., with reference to FIGS. 8a-8c.

The heating element 2 has an extension along a first axis 4, indicated with broken lines. An alternative extension of the first axis 4′ is indicated with a dash-dotted line in FIG. 1a. The fluid to be heated in the heating element 2, flows along a fluid flow path in parallel with the first axis 4, 4′ through the heating element 2.

The heating element 2 comprise a first region 6, a second region 8, and a third region 10.

The heating element 2 comprises at least three fluid permeable heating panels 11, 11′, 12, 12′, 13, 13′. The heating panels 11, 11′, 12, 12′, 13, 13′ are arranged adjacent to each with an interspace between adjacent heating panels 11, 11′, 12, 12′, 13, 13′. The heating panels 11, 11′, 12, 12′, 13, 13′ may be arranged along and/or in parallel with the first axis 4, 4′.

According to some embodiments, as in the illustrated embodiments, the heating panels 11, 11′, 12, 12′, 13, 13′ may be arranged extending in parallel with each other.

Each of the at least three fluid permeable heating panels 11, 11′, 12, 12′, 13, 13′ comprises a 3-dimensional structure, the 3-dimensional structure comprising a multitude of members 45 of at least one electrically conductive material, see FIG. 1c.

The 3-dimensional structure comprising the multitude of members 45 provides for the fluid permeability of each heating panel 11, 11′, 12, 12′, 13, 13′. In the 3-dimensional structure, between the multitude of members 45 a multitude of voids are present, through which voids fluid can penetrate the heating panels 11, 11′, 12, 12′, 13, 13′.

The 3-dimensional structure comprises at least three members 45 arranged after each other along the first axis 4 and connected to each other at nodes 47.

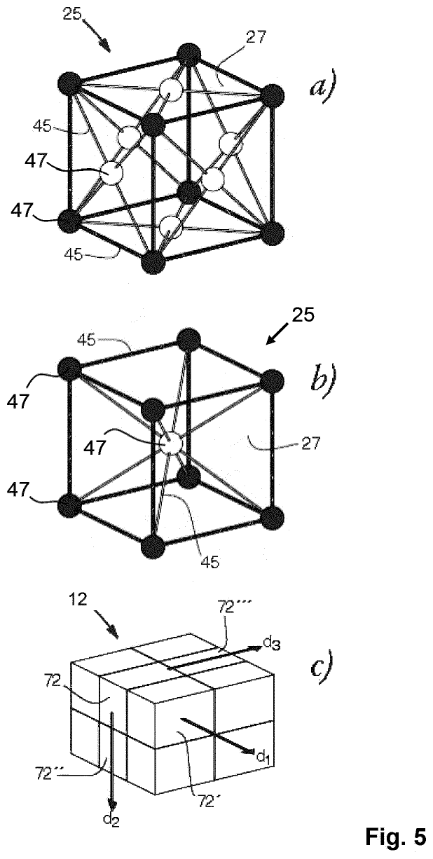

The 3-dimensional structure of the heating panels 11, 11′, 12, 12′, 13, 13′ is discussed in more detail below with reference to FIGS. 5a)-5c).

The heating element 2 has a 3-dimensional shape which is delimited in part by a first lateral side 14 and an opposite second lateral side 16. The first and second lateral sides 14, 16 extend substantially in parallel with the first axis 4, 4′. The fluid permeable heating panels 11, 11′, 12, 12′, 13, 13′ extend between the first and second lateral sides 14, 16. That is, the heating panels 11, 11′, 12, 12′, 13, 13′ extend across a direction defined by the first axis 4, 4′.

Specifically, each of the at least three fluid permeable heating panels 11, 11′, 12, 12′, 13, 13′ extends between the first and second lateral sides 14, 16.

In the illustrated embodiments, the heating element 2 has a generally rectangular cuboid shape. Accordingly, in these and other embodiments, the 3-dimensional shape of the heating element 2 is delimited by further opposed lateral sides 18, 20. Also the further lateral sides 18, 20 extend substantially in parallel with the first axis 4.

A lateral side 14, 16, 18, 20 extending substantially in parallel with the first axis 4 may mean that the relevant lateral side extends at an angle within a range of 0-5 degrees to the first axis 4.

The first region 6 comprises a first fluid permeable heating panel 11 of the at least three fluid permeable heating panels 11, 11′, 12, 12′, 13, 13′, the second region 8 comprises a second fluid permeable heating panel 12 of the at least three fluid permeable heating panels 11, 11′, 12, 12′, 13, 13′, and the third region 10 comprises a third fluid permeable heating panel 13 of the at least three fluid permeable heating panels 11, 11′, 12, 12′, 13, 13′.

Each of the first, second, and third region 6, 8, 10 is configured to form one phase of a 3-phase electrical load. This is achieved:
Either by a common electrical conductor 22 connecting the first, second, and third regions 6, 8, 10, see FIG. 1a.
Or by a first electrical conductor 23, a second electrical conductor 24, and a third electrical conductor 26 each connecting two of the first region 6, the second region 8, and the third region 10, see FIG. 1b.

Accordingly, in the different embodiments of FIGS. 1a and 1b the first, second, and third regions 6, 8, 10 are configured to each form a load to be connected to a three-phase alternating current mains electrical power. In the embodiments of FIG. 1a, the regions 6, 8, 10 are arranged in a star configuration and in the embodiments of FIG. 1b, the regions 6, 8, 10 are arranged in a delta configuration.

In the embodiments of FIG. 1a, each region 6, 8, 10 only comprises one heating panel 11, 12, 13. In the embodiments of FIG. 1b, each region 6, 8, 10 comprises two heating panels 11, 11′, 12, 12′, 13, 13′ electrically connected in series via electrical connectors 28.

In the embodiments of FIG. 1a, the heating element 2 comprises three terminals 30, one for each phase, for connecting electrical power to the heating element 2, as indicated by the dash-dotted lines. The common electrical conductor 22 forms the centre of the star configuration of the three regions 6, 8, 10.

In the embodiments of FIG. 1b, the heating element 2 comprises three terminals 30, one for each phase, for connecting electric power to the heating element 2, as indicated by the dash-dotted lines. In these embodiments, the three terminals 30 are integrated with the first, second, and third electrical conductors 23, 24, 26.

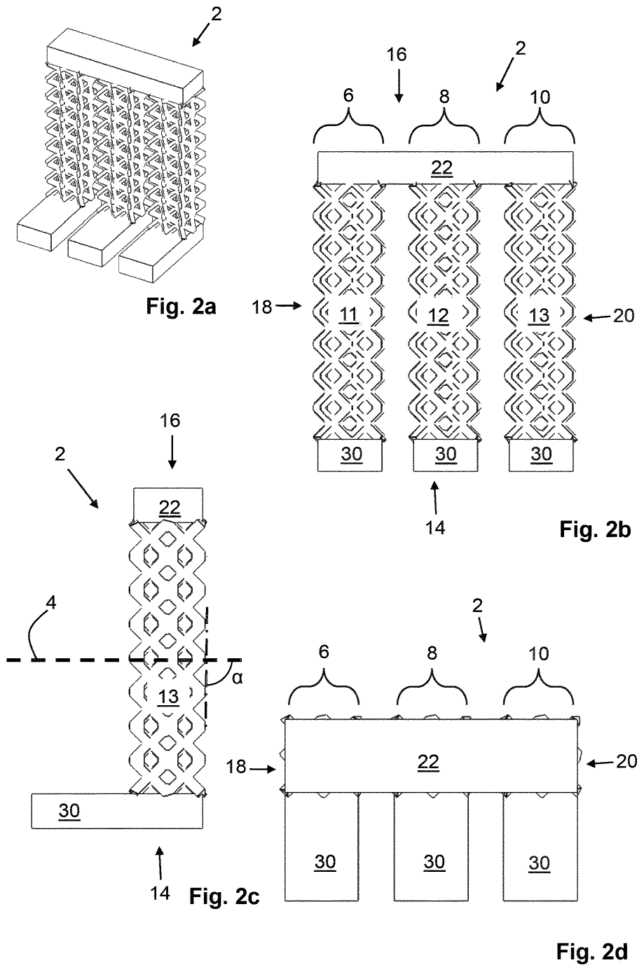

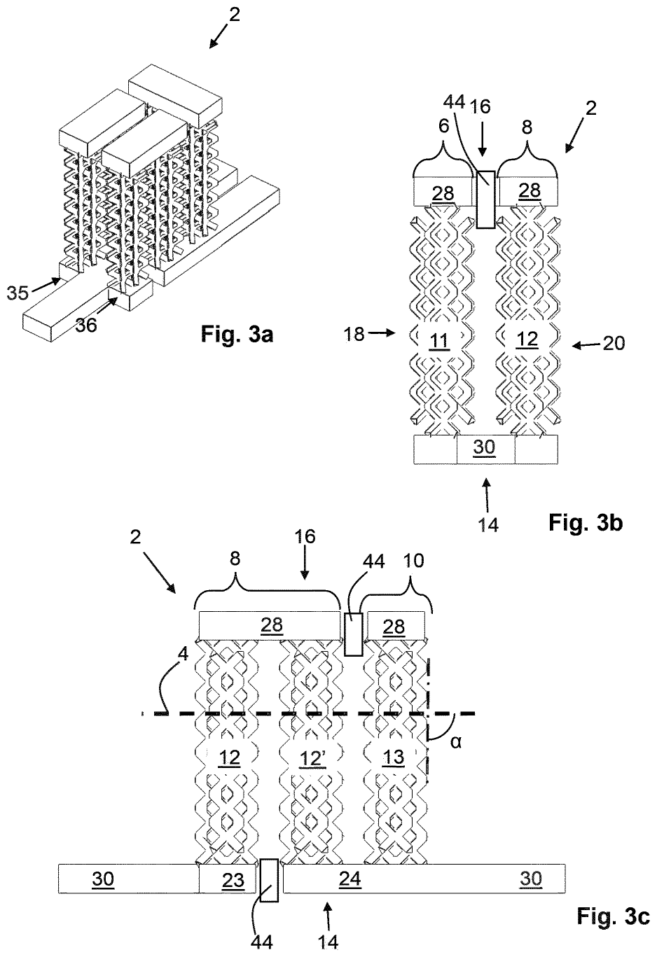

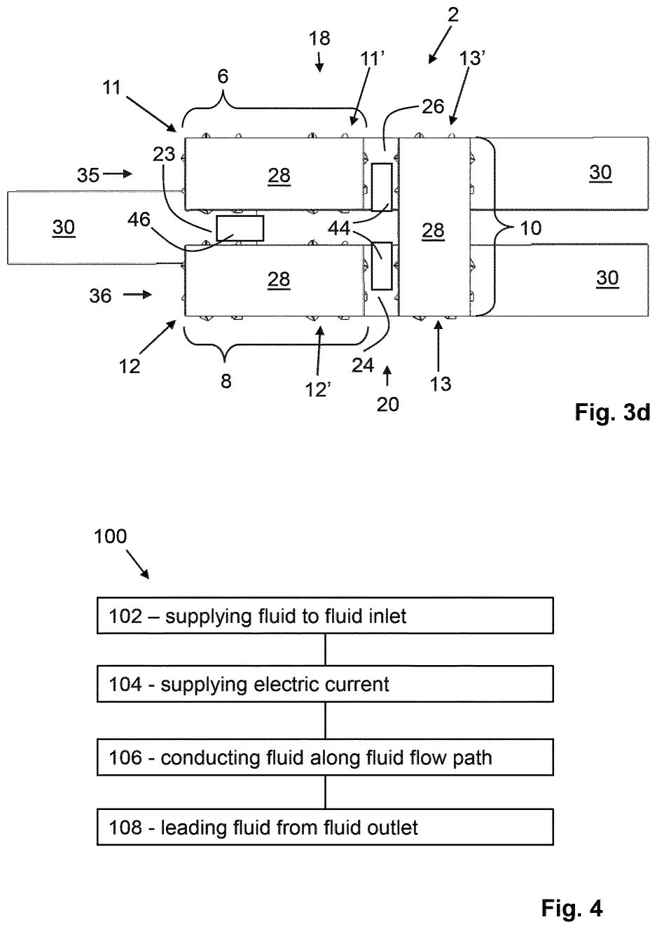

The embodiments of FIG. 1a are discussed in more detail below with reference to FIGS. 2a-2d. The embodiments of FIG. 1b are discussed in more detail below with reference to FIGS. 3a-3d.

FIGS. 2a-2d illustrate the heating element 2 according to the FIG. 1a embodiments in more detail. FIG. 2a corresponds to the isometric view of FIG. 1a, FIGS. 2b and 2c show respective side views and FIG. 2d shows a top view of the heating element 2.

Accordingly, the heating element 2 has an extension along the first axis 4 and comprises the first region 6, the second region 8, and the third region 10. Each region 6 comprises a fluid permeable heating panel 11, 12, 13. The heating panels 11, 12, 13 are arranged adjacent to each other with an interspace between adjacent heating panels 11, 12, 13.

Each of the heating panels 11, 12, 13 extends at an angle α within a range of 45-90 degrees to the first axis 4. In the illustrated embodiments, the heating panels 11, 12, 13 extend perpendicularly to the first axis 4 i.e., the angle α is 90 degrees.

The heating element 2 has a 3-dimensional shape which is delimited in part by the first lateral side 14 and the opposite second lateral side 16. The first and second lateral sides 14, 16 extend substantially in parallel with the first axis 4. The fluid permeable heating panels 11, 12, 13 extend between the first and second lateral sides 14, 16.

The 3-dimensional shape of the heating element 2 is delimited by the further opposed lateral sides 18, 20.

Each of the first, second, and third region 6, 8, 10 is configured to form one phase of a 3-phase electrical load. In these embodiments this is achieved by the common electrical conductor 22 connecting the first, second, and third regions 6, 8, 10. The regions 6, 8, 10 are arranged in a star configuration.

Three terminals 30, one for each phase, are provided for connection of the regions 6, 8, 10 to 3-phase mains electrical power.

FIGS. 3a-3d illustrate the heating element 2 according to the FIG. 1b embodiments in more detail. FIG. 3a corresponds to the isometric view of FIG. 1b, FIGS. 3b and 3c show respective side views and FIG. 3d shows a top view of the heating element 2.

Again, the heating element 2 has an extension along the first axis 4 and comprises the first, second, and third regions 6, 8, 10. Each region 6, 18, 10 comprises a fluid permeable heating panel 11, 11′, 12, 12′, 13, 13′. The heating panels 11, 11′, 12, 12′, 13, 13′ are arranged adjacent to each with an interspace between adjacent heating panels 11, 11′, 12, 12′, 13, 13′.

Each of the heating panels 11, 11′, 12, 12′, 13, 13′ extends at an angle α within a range of 45-90 degrees to the first axis 4. In the illustrated embodiments, the heating panels 11, 11′, 12, 12′, 13, 13′ extend perpendicularly to the first axis 4 i.e., the angle α is 90 degrees.

The heating element has a 3-dimensional shape which is delimited in part by the first lateral side 14 and the opposite second lateral side 16. The first and second lateral sides 14, 16 extend substantially in parallel with the first axis 4. The fluid permeable heating panels 11, 11′, 12, 12′, 13, 13′ extend between the first and second lateral sides 14, 16. The heating element 2 is delimited by further opposed lateral sides 18, 20.

Each of the first, second, and third region 6, 8, 10 is configured to form one phase of a 3-phase electrical load. In these embodiments this is achieved by the first electrical conductor 23, the second electrical conductor 24, and the third electrical conductor 26 each connecting two of the first region 6, the second region 8, and the third region 10. The regions 6, 8, 10 are arranged in a delta configuration.

Three terminals 30, one for each phase, are provided for connection of the regions 6, 8, 10 to 3-phase mains electrical power.

The heating element 2 comprises two rows 35, 36 of fluid permeable heating panels arranged adjacent to each other along the first axis 4.

A first row 35 includes fluid permeable heating panels 11, 11′, 13′ of the first and third regions 6, 10 and the other row 36 includes heating panels 12, 12′, 13 of the second and third regions 8, 10.

In these embodiments, each region 6, 8, 10 comprises two heating panels 11, 11′, 12, 12′, 13, 13′, see particularly FIG. 3d.

More specifically, the first region 6 comprises the first heating panel 11 and one additional first fluid permeable heating panel 11′. The additional first fluid permeable heating panel 11′ forms part of the at least three fluid permeable heating panels 11, 11′, 12, 12′, 13, 13′ of the heating element 2. The first fluid permeable heating panel 11 and the additional first fluid permeable heating panel 11′ are electrically connected in series via an electrical connector 28 arranged at the second lateral side 16.

Similarly, the second region 8 comprises the second heating panel 12 and one additional second fluid permeable heating panel 12′ of the at least three fluid permeable heating panels 11, 11′, 12, 12′, 13, 13′. The second fluid permeable heating panel 12 and the additional second fluid permeable heating panel 12′ are electrically connected in series via an electrical connector 28 arranged at the second lateral side 16. The third region 10 comprise the third heating panel 13 and one additional third fluid permeable heating panel 13′ of the at least three fluid permeable heating panels 11, 11′, 12, 12′, 13, 13′. The third fluid permeable heating panel 13 and the additional third fluid permeable heating panel 13′ are electrically connected in series via an electrical connector 28 arranged at the second lateral side 16.

Since in these embodiments the heating element 2 comprises two rows 35, 36 of heating panels and three regions 6, 8, 10 some electrical connectors 28 extend between adjacent fluid permeable heating panels 11, 11′, 12, 12′, within each row 35, 36 of fluid permeable heating panels and other electrical connectors 28 extend between adjacent fluid permeable heating panels 13, 13′ of adjacent rows 35, 36 of fluid permeable heating panels.

FIGS. 5a)-5c) schematically illustrate unit cells 25 and their arrangement in a heating panel 12 or additional heating panel of a heating element 2 as discussed herein. See also e.g., FIGS. 1a-3d. References below to the heating panels 12 also relates to the heating panels 11, 13 and the additional heating panels 11′, 12′, 13′.

FIGS. 5a) and 5b) each illustrates one so-called unit cell 25. The unit cell 25 comprises members 45 connected at nodes 47. In the context of a unit cell 25 the above discussed members 45 may alternatively be referred to as struts. In a heating panel 12 of a heating element 2 there are arranged a multitude of unit cells 25. That is, the members 45 of the 3-dimensional structure are connect at nodes 47 to form a multitude of unit cells 25.

FIGS. 5a) and 5b) illustrate examples of the smallest repeating structure of the 3-dimensional structure, a unit cell 25. Each unit cell 25 is formed from solid members 45 that are joined at the nodes 47. There are voids 27 between the members 45 and the nodes 47.

Accordingly, the regularly repeating structure of members 45 and nodes 47 with the voids therebetween is a fluid permeable structure. The fluid flow is heated by the electrically heated members 45 and nodes 47 as it passes through the fluid permeable structure.

Such unit cells 25 may be repeated throughout at least a main portion of the 3-dimensional structure.

In different heating panels 12 of a heating element 2, the 3-dimensional structure may comprise different unit cell geometries to form heating panels 12 that differ in the size, shape and multiplicity of the members 45 and/or the voids 27.

The example unit cell configuration of FIG. 5a), it is a face-centred-cubic (fcc) unit cell 25. The example unit cell configuration of FIG. 5b), it is body-centred-cubic (bcc) unit cell 25.

According to some embodiments, the 3-dimensional structure of each heating panel 12 comprises at least three members 45 arranged after each other along the first axis 4 and connected to each other at nodes 47. This means in embodiments wherein the 3-dimensional structure comprises fcc unit cells 25 as shown in FIG. 5a) or bcc unit cells 25 as shown in FIG. 5b), that the 3-dimensional structure comprises at least one-and-a-half unit cells 25 arranged along the first axis 4.

In a 3-dimensional structure comprising simple cubic unit cells i.e., without any centred nodes, the feature that the 3-dimensional structure comprises at least three members 45 arranged after each other along the first axis 4 and connected to each other at nodes 47 means, that the 3-dimensional structure comprises at least three unit cells 25 arranged along the first axis 4.

A unit cell 25 may have a diameter, or width of at least 0.1 mm. A thickness of each member 45 may be within a range of 0.05-10 mm, or within a range of 0.1-4 mm, or within a range of 0.2-1 mm, and a length of each member 45 may be within a range of 0.1-50 mm, or within a range of 0.2-15 mm or within a range of 0.5-5 mm.

The thickness of a member 45 extends perpendicularly to the longitudinal extension of the member 45 between two nodes 47. When the thickness of a member 45 varies, the above discussed thickness ranges relate to a mean thicknesses of the member 45.

FIG. 5c) illustrates a number of unit cells 72 of a portion of a 3-dimensional structure of a heating panel 12. Each unit cell 72 is schematically shown as a cube and may be of one of the kinds discussed in connection with FIGS. 5a) and 5b). However, the unit cells 72 are not limited to the shown embodiments but may have any suitable internal structure of members and any suitable other outer shape, such as e.g. a tetrahedron shape or octahedron shape.

The unit cells 72 are arranged next to each other in three dimensions. Members and nodes of adjacent unit cells 72 are shared to form a regularly repeating 3-dimensional structure in the heating panel 12. More specifically, at corners of each unit cell 72, members from adjacent unit cells 72 are connected to each other and thus, form nodes. Since each unit cell 72, except at outer surfaces of the heating panel 12, is surrounded by other unit cells 72, the unit cells are positioned next to each other in three dimensions. For instance, the heating panel 12 comprises at least two unit cells 72, 72′ positioned adjacent to each other in a first direction d1, at least two unit cells 72, 72″ positioned adjacent to each other in a second direction d2, and at least two unit cells 72, 72″ positioned adjacent to each other in a third direction d3, wherein the first, second, and third directions d1, d2, d3 are arranged at an angle to each other. For instance, if the unit cells 72 have cubic shape, as illustrated, the three directions d1, d2, d3 are orthogonal, if the unit cells 72 have tetrahedron shape, the three directions extend at an angle of 120 degrees to each other.

According to some embodiments, one of the first, second, and third directions d1, d2, d3 may coincide with the first axis 4.

According to some embodiments, different basic unit cells may be superimposed. For instance, an FCC unit cell may be added to a BCC unit cell and they may be manufactured simultaneously e.g., by additive manufacturing. Further, the 3-dimensional structure may comprise different types of unit cells occupying the same volume. By different types of unit cells are meant for example unit cells having different configuration, being differently sized e.g., different thicknesses of the members.

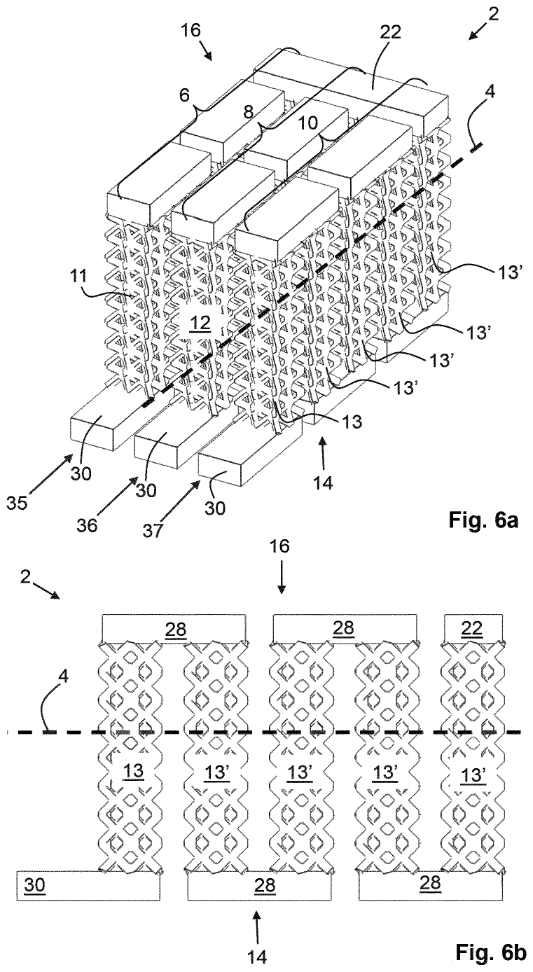

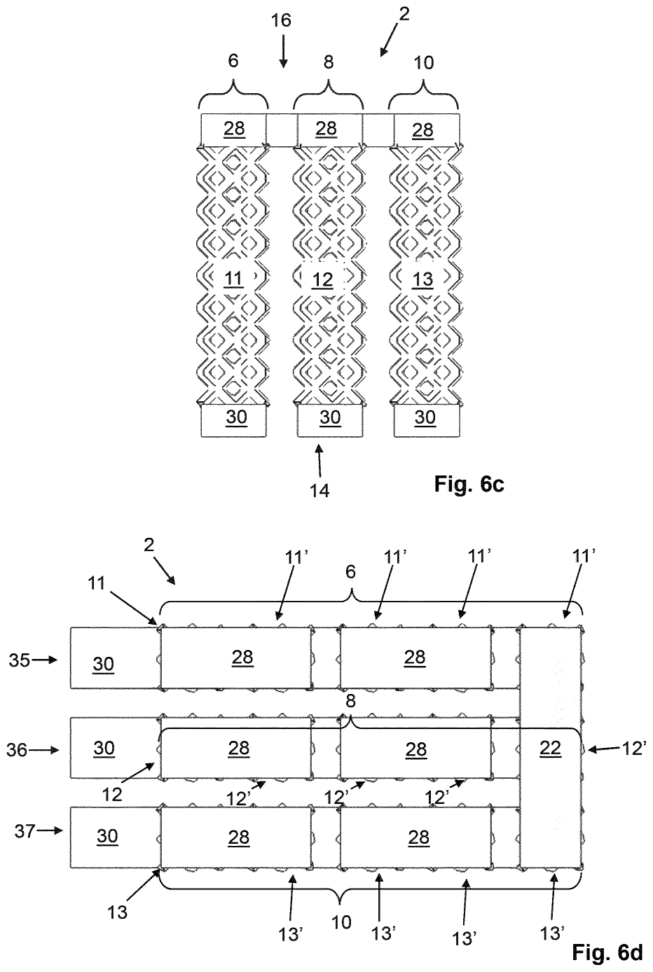

FIGS. 6a-6d illustrate a heating element 2 according to embodiments. FIG. 6a shows an isometric view, FIGS. 6b and 6c show respective side views, and FIG. 6d shows a top view of the heating element 2.

These embodiments resemble in principle the embodiments of FIGS. 1a and 2a-2d. That is, in these embodiments again, the regions 6, 8, 10 are arranged in a star configuration. Accordingly, in the following mainly the differences will be discussed.

Again, the heating element 2 has an extension along a first axis 4 and comprises a first region 6, a second region 8, and a third region 10. Each region 6 comprises a fluid permeable heating panel 11, 12, 13 of the at least three heating panels 11, 11′, 12, 12′, 13, 13′ of the heating element 2.

Again, the heating element 2 has a 3-dimensional shape which is delimited in part by a first lateral side 14 and an opposite second lateral side 16. The first and second lateral sides 14, 16 extend substantially in parallel with the first axis 4. The fluid permeable heating panels 11, 11′, 12, 12′, 13, 13′ extend between the first and second lateral sides 14, 16.

Each of the first, second, and third region 6, 8, 10 is configured to form one phase of a 3-phase electrical load. A common electrical conductor 22 connects the first, second, and third regions 6, 8, 10. The regions 6, 8, 10 are arranged in a star configuration.

Again, three terminals 30, one for each phase, are provided for connection of the regions 6, 8, 10 to 3-phase mains electrical power.

In the present embodiments, each region 6, 8, 10 comprises a number of heating panels 11, 11′, 12, 12′, 13, 13′ connected in series via electrical connectors 28. (For the sake of clarity, not all electrical connectors have been indicated with reference number 28 in the figures.) In addition to the first, second, and third heating panels 11, 12, 13, the heating element 2 comprises 12 additional heating panels 11′, 12′, 13′, such that each region 6, 8, 10 comprises 5 heating panels 11, 11′, 12, 12′, 13, 13′ connected in series.

More specifically, the first region 6 comprises four additional first fluid permeable heating panels 11′. The first fluid permeable heating panel 11 and the four additional first fluid permeable heating panels 11′ are electrically connected in series via four electrical connectors 28 arranged at the first and second lateral sides 14, 16. Similarly, the second region 8 comprises four additional second fluid permeable heating panels 12′. The second fluid permeable heating panel 12 and the four additional second fluid permeable heating panels 12′ are electrically connected in series via four electrical connectors 28 arranged at the first and second lateral sides 14, 16. Similarly, the third region 10 comprises four additional third fluid permeable heating panels 13′. The third fluid permeable heating panel 13 and the four additional third fluid permeable heating panels 13′ are electrically connected in series via four electrical connectors 28 arranged at the first and second lateral sides 14, 16.

The heating panels 11, 11′, 12, 12′, 13, 13′ of the heating element 2 are arranged in at least two rows 35, 36, 37 of fluid permeable heating panels adjacent to each other along the first axis 4.

The first fluid permeable heating panel 11 and the four additional first fluid permeable heating panels 11′ of the first region 6 are arranged in a first row 35 of the at least two rows 35, 36, 37 of fluid permeable heating panels and the second fluid permeable heating panel 12 and the four additional second fluid permeable heating panels 12′ of the second region 8 are arranged in a second row 36 of the at least two rows 35, 36, 37 of fluid permeable heating panels.

Similarly, the third fluid permeable heating panel 13 and the four additional third fluid permeable heating panels 13′ of the third region 10 are arranged in third rows 37 of fluid permeable heating panels.

Accordingly, each of the rows 35, 36, 37 includes respective fluid permeable heating panels 11, 11′, 12, 12′, 13, 13′ of the respective first, second, and third regions 6, 8, 10.

In the illustrated embodiments, the heating element 2 comprises 15 heating panels 11, 11′, 12, 12′, 13, 13′ arranged with five heating panels 11, 11′, 12, 12′, 13, 13′ in each region 6, 8, 10, the regions 6, 8, 10 being arranged in a star configuration.

According to alternative embodiments, the heating element 2 may comprise at least six heating panels arranged with at least two heating panels in each of three regions, the regions being arranged in a star configuration.

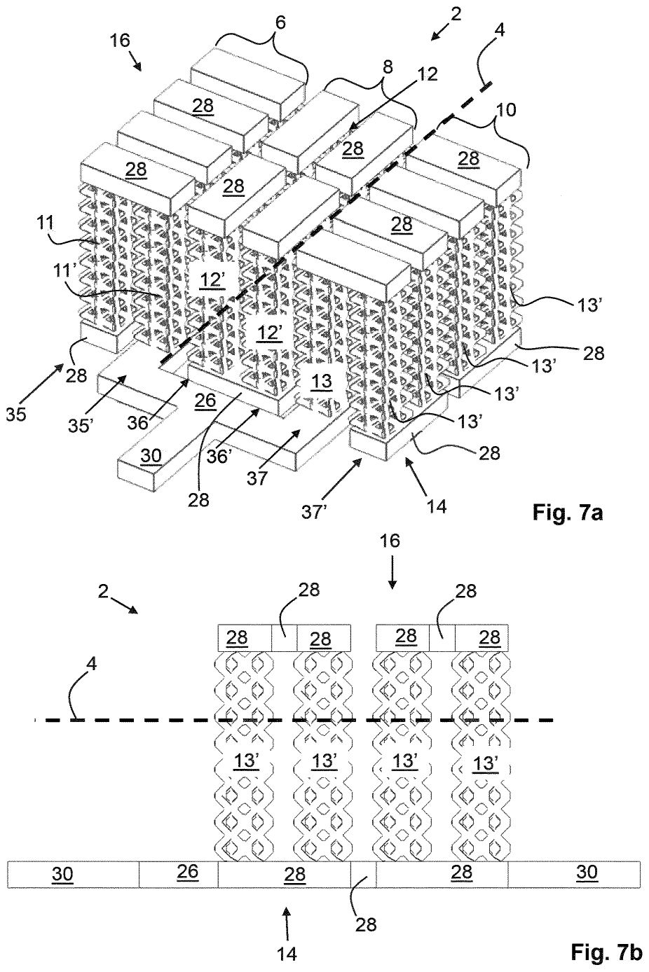

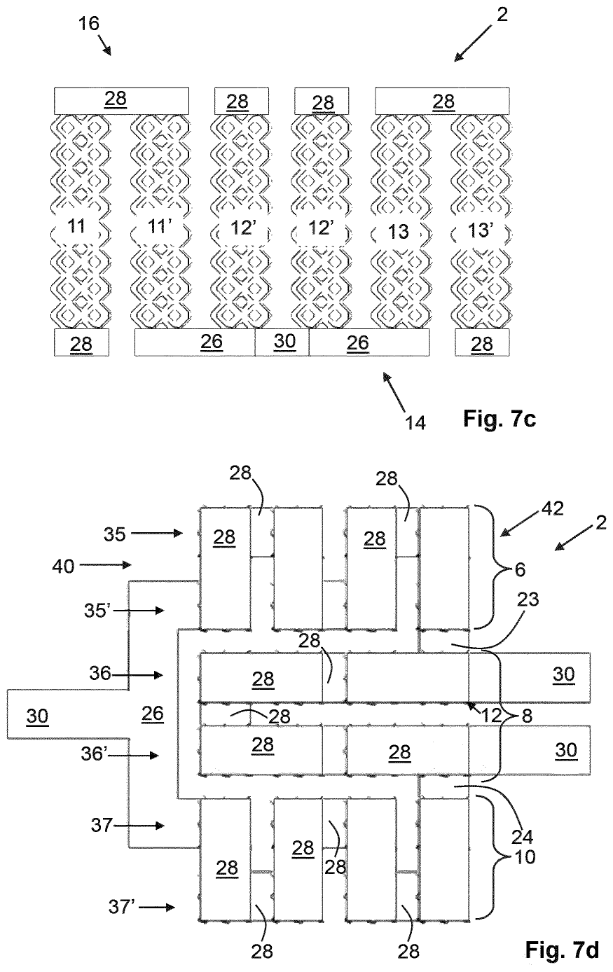

FIGS. 7a-7c illustrate a heating element 2 according to embodiments. FIG. 7a shows an isometric view, FIGS. 7b and 7c show respective side views, and FIG. 7d shows a top view of the heating element 2.

These embodiments resemble in principle the embodiments of FIGS. 1b and 3a-3d. That is, in these embodiments again, the regions 6, 8, 10 are arranged in in a delta configuration. Accordingly, in the following mainly the differences will be discussed.

Again, the heating element 2 has an extension along a first axis 4 and comprises a first region 6, a second region 8, and a third region 10. Each region 6 comprises a fluid permeable heating panel 11, 12, 13 of the at least three heating panels 11, 11′, 12, 12′, 13, 13′ of the heating element 2.

Again, the heating element 2 has a 3-dimensional shape which is delimited in part by a first lateral side 14 and an opposite second lateral side 16. The first and second lateral sides 14, 16 extend substantially in parallel with the first axis 4. The fluid permeable heating panels 11, 11′, 12, 12′, 13, 13′ extend between the first and second lateral sides 14, 16.

Each of the first, second, and third region 6, 8, 10 is configured to form one phase of a 3-phase electrical load. A first electrical conductor 23, a second electrical conductor 24, and a third electrical conductor 26 connect the first, second, and third regions 6, 8, 10 in pairs. The regions 6, 8, 10 are arranged in a delta configuration.

Again, three terminals 30, one for each phase, are provided for connection of the regions 6, 8, 10 to 3-phase mains electrical power.

Again, each region 6, 8, 10 comprises a number of heating panels 11, 11′, 12, 12′, 13, 13′ connected in series via electrical connectors 28. (For the sake of clarity, not all electrical connectors have been indicated with reference number 28 in the figures.)

In addition to the first, second, and third heating panels 11, 12, 13, the heating element 2 comprises one or more, such as in these embodiments 21, additional heating panels 11′, 12′, 13′, such that each region 6, 8, 10 comprises 8 heating panels 11, 11′, 12, 12′, 13, 13′ connected in series.

More specifically, the first region 6 comprises seven additional first fluid permeable heating panels 11′. The first fluid permeable heating panel 11 and the seven additional first fluid permeable heating panels 11′ are electrically connected in series via seven electrical connectors 28 arranged at the first and second lateral sides 14, 16. Similarly, the second region 8 comprises seven additional second fluid permeable heating panels 12′. The second fluid permeable heating panel 12 and the seven additional second fluid permeable heating panels 12′ are electrically connected in series via seven electrical connectors 28 arranged at the first and second lateral sides 14, 16. Similarly, the third region 10 comprises seven additional third fluid permeable heating panels 13′. The third fluid permeable heating panel 13 and the seven additional third fluid permeable heating panels 13′ are electrically connected in series via seven electrical connectors 28 arranged at the first and second lateral sides 14, 16.

Again, the heating panels 11, 11′, 12, 12′, 13, 13′ of the heating element 2 are arranged in at least two rows 35, 35′, 36, 36′, 37, 37′ of fluid permeable heating panels adjacent to each other along the first axis 4. In these embodiments, the heating panels 11, 11′, 12, 12′, 13, 13′ are arranged in six rows 35, 35′, 36, 36′, 37, 37′.

The first fluid permeable heating panel 11 and three additional first fluid permeable heating panels 11′ of the first region 6 are arranged in a first row 35 of the at least two rows 35, 35′, 36, 36′, 37, 37′ of fluid permeable heating panels. The second fluid permeable heating panel 12 and three additional second fluid permeable heating panels 12′ of the second region 8 are arranged in a second row 36 of the at least two rows 35, 35′, 36, 36′, 37, 37′ of fluid permeable heating panels.

Additionally, as in these embodiments, the third fluid permeable heating panel 13 and three additional second fluid permeable heating panels 13′ of the third region 10 may be arranged in a third row 37 of the at least two rows 35, 35′, 36, 36′, 37, 37′ of fluid permeable heating panels.

According to some embodiments, as in these embodiments, the first fluid permeable heating panel 11 and the one or more additional first fluid permeable heating panels 11′ of the first region 6 are arranged in the first row 35 of fluid permeable heating panels and an additional first row 35′ of fluid permeable heating panels of the at least two rows 35, 35′, 36, 36′, 37, 37′ of fluid permeable heating panels. The second fluid permeable heating panel 12 and the one or more additional second fluid permeable heating panels 12′ of the second region 8 are arranged in the second row 36 of fluid permeable heating panels 12′ and an additional second row 36′ of fluid permeable heating panels of the at least two rows 35, 35′, 36, 36′, 37, 37′ of fluid permeable heating panels. In this manner, a compact heating element 2 may be provided with each region 6, 8 of the heating element 2 arranged in two rows 35, 35′, 36, 36′ along the first axis 4.

Additionally, as in these embodiments, the third fluid permeable heating panel 13 and the one or more additional third fluid permeable heating panels 13′ of the third region 8 may be arranged in a third row 37 of fluid permeable heating panels and an additional third row 37′ of fluid permeable heating panels of the at least two rows 35, 35′, 36, 36′, 37, 37′ of fluid permeable heating panels.

According to some embodiments, as in these embodiments, the first fluid permeable heating panel 11 and the one or more additional first fluid permeable heating panels 11′ of the first row 35 of fluid permeable heating panels and the additional first row 35′ of fluid permeable heating panels are electrically connected in series along an electrically conductive path via the electrical connectors 28 being arranged at the first and second lateral sides 14, 16. Some of the electrical connectors 28 extend between adjacent fluid permeable heating panels 11, 11′ within the first row 35 of fluid permeable heating panels, some of the electrical connectors 28 extend between adjacent fluid permeable heating panels 11, 11′ within the additional first row 35′ of fluid permeable heating panels, and some of the electrical connectors 28 extend between adjacent fluid permeable heating panels 11, 11′ of the first row 35 of fluid permeable heating panels and the additional first row 35′ of fluid permeable heating panels. In this manner, the fluid permeable heating panels 11, 11′ within the first region 6, arranged in two rows 35, 35′, may be electrically connected in series.

Additionally, as in these embodiments, the second fluid permeable heating panel 12 and the one or more additional first fluid permeable heating panels 12′ of the second row 36 of fluid permeable heating panels and the additional second row 36′ of fluid permeable heating panels may be electrically connected in series along an electrically conductive path via the electrical connectors 28 being arranged at the first and second lateral sides 14, 16. Some of the electrical connectors 28 extend between adjacent fluid permeable heating panels 12, 12′ within the second row 36 of fluid permeable heating panels, some of the electrical connectors 28 extend between adjacent fluid permeable heating panels 12, 12′ within the additional second row 36′ of fluid permeable heating panels, and some of the electrical connectors 28 extend between adjacent fluid permeable heating panels 12, 12′ of the second row 36 of fluid permeable heating panels and the additional second row 36′ of fluid permeable heating panels. In this manner, the fluid permeable heating panels 12, 12′ within the second region 8, arranged in two rows 36, 36′, may be electrically connected in series.

Additionally, as in these embodiments, the third fluid permeable heating panel 13 and the one or more additional third fluid permeable heating panels 13′ of the third row 37 of fluid permeable heating panels and the additional third row 37′ of fluid permeable heating panels are electrically connected in series along an electrically conductive path via the electrical connectors 28 being arranged at the first and second lateral sides 14, 16. Some of the electrical connectors 28 extend between adjacent fluid permeable heating panels 13, 13′ within the third row 37 of fluid permeable heating panels, some of the electrical connectors 28 extend between adjacent fluid permeable heating panels 13, 13′ within the additional third row 37′ of fluid permeable heating panels, and some of the electrical connectors 28 extend between adjacent fluid permeable heating panels 13, 13′ of the third row 37 of fluid permeable heating panels and the additional third row 37′ of fluid permeable heating panels. In this manner, the fluid permeable heating panels 13, 13′ within the third region 10, arranged in two rows 37, 37′, may be electrically connected in series.

Accordingly, in these embodiments, each region 6, 8, 10 comprises six rows 35, 35′, 36, 36′, 37, 37′ of fluid permeable heating panels.

Within each region 6, 8, 10, some of the electrical connectors 28 extend between adjacent heating panels 11, 11′, 12, 12′, 13, 13′ within a row 35, 35′, 36, 36′, 37, 37′ of heating panels and some of the electrical connectors 28 extend between heating panels 11, 11′, 12, 12′, 13, 13′ of adjacent rows 35, 35′, 36, 36′, 37, 37′ of heating panels. As clearly shown in FIG. 7d, the electrically conductive path is meandering through the heating element 2 along and perpendicularly to the first axis 4. The electrically conductive path may meander from one end portion 40 of the heating element 2 to an opposite end portion 42, seen along the first axis 4, as in the first and third regions 6, 10 in these embodiments. Alternatively, electrically conductive path may meander from one end portion 40, 42 back to the same end portion 40, 42, as in the second region 8.

In the illustrated embodiments, the heating element 2 comprises 24 heating panels 11, 11′, 12, 12′, 13, 13′ arranged with eight heating panels 11, 11′, 12, 12′, 13, 13′ in each region 6, 8, 10, the regions 6, 8, 10 being arranged in a delta configuration.

According to alternative embodiments, the heating element 2 may comprise more than at least six heating panels arranged with at least two heating panels in each of three regions, the regions being arranged in a delta configuration.

The following discussion relates to heating elements 2 according to one or more of the above discussed embodiments.

Each of the at least three fluid permeable heating panels 11, 11′, 12, 12′, 13, 13′ may be a result of an additive manufacturing process.

The common electrical conductor 22 and each of the first, second, and third electrical conductors 23, 24, 26 may be a result of an additive manufacturing process.

According to some embodiments, each of the one or more electrical connectors 28 may be a result of an additive manufacturing process. In this manner, the electrical connectors 28 may be efficiently manufactured e.g., in a same manufacturing process as the heating panels 11, 11′, 12, 12′, 13, 13′ and/or the common electrical conductor 22 or the first, second, and third electrical conductors 23, 24, 26.

According to some embodiments, the terminals 30 may be a result of an additive manufacturing process. In this manner, the terminals 30 may be efficiently manufactured e.g., in a same manufacturing process as heating panels 11, 11′, 12, 12′, 13, 13′ and/or as the electrical connectors 28 and/or the common electrical conductor 22 or the first, second, and third electrical conductors 23, 24, 26.

The at least one electrically conductive material used may be any material which can conduct electricity. Thus, the material may be selected from the group of: iron-chromium-aluminium alloy, nickel-chromium alloy, copper-nickel based alloy, iron-nickel-chromium alloy, nickel-iron-chromium-aluminium alloy, ceramic material, intermetallic material, tungsten containing composition, molybdenum containing composition, silicon containing composition, stainless steel, and titanium alloy or a combination thereof.

According to some embodiments, the fluid permeable heating panels 11, 11′, 12, 12′, 13, 13′ may be configured to be electrically heated up to a temperature of 1450 degrees Celsius, up to a temperature of 1900 degrees Celsius, or up to a temperature within a range of 1700-1900 degrees Celsius, or up to a temperature within a range of 1600-2000 degrees Celsius. In this manner, the fluid to be heated may be heated to high temperatures, which may be utilised in industrial processes.

Such a temperature or temperature range may be applied in heaters wherein the electrically conducting material is selected from any of the above-mentioned alloys.

According to some embodiments, such a temperature of up to 150 degrees Celsius may be applied in heating elements 2 wherein the electrically conducting material is an iron-chromium-aluminium alloy or a stainless steel.

According to some embodiments, such a temperature of up to 1900 degrees Celsius or the temperature range of 1700-1900 degrees Celsius may be applied in heating elements wherein the electrically conducting material is a molybdenum containing composition.

According to some embodiments, such a temperature of up to 2000 degrees Celsius or the temperature range of 1600-2000 degrees Celsius may be applied in heating elements wherein the electrically conducting material is a silicon containing composition, such as silicon carbide.

According to some embodiments, within the heating element 2 the first fluid permeable heating panel 11 may differ from the additional first fluid permeable heating panel 11′ by any one or a combination of:
the 3-dimensional structure;
a cross-sectional area, thickness or width of the members 45;
a size, shape, or number of voids within the fluid permeable heating panels 11, 11′;
a length along the first axis 4 of the fluid permeable heating panels 11, 11′. In this manner, properties of the heating element 2 may differ along the first axis 4.

According to embodiments, the heating panels 11, 11′, 12, 12′, 13, 13′ may be designed and arranged for an energy transfer of up to 5 kW/cm3. In this manner, a compact heating element 2 providing a high, and thus, efficient energy transfer, may be provided.

In the following discussion reference is made to FIGS. 3b-3d. However, spacer elements 44 and further spacer elements 46 may be applied in the same manner in the embodiments of FIGS. 2a-2d, and 6a-7d.

The heating element 2 may comprise electrically non-conductive spacer elements 44 arranged at the first and second lateral sides 14, 16 between adjacent fluid permeable heating panels 11, 11′, 12, 12′, 13, 13′. As mentioned above, thus, it may be ensured that individual heating panels 11, 11′, 12, 12′, 13, 13′ are not short circuited within the heating element 2. Also, a stability of the heating element 2 may be positively affected by the provision of the spacer elements 44.

Further, in embodiments wherein the heating element 2 comprises at least two rows 35, 35′, 36, 36′, 37, 37′ of fluid permeable heating panels, the heating element 2 may comprise at least one electrically non-conductive further spacer element 46 arranged between fluid permeable heating panels 11, 11′, 12, 12′, 13, 13′ of adjacent rows 35, 35′, 36, 36′, 37, 37′ of fluid permeable heating panels of the at least two rows 35, 35′, 36, 36′, 37, 37′ of fluid permeable heating panels. Thus, it may be ensured that individual heating panels do not short circuit between rows of heating panels within the heating element 2. Also, a stability of the heating element may be positively affected by the provision of the further spacer elements 46.

In embodiments comprising more than one row of heating elements, the spacer elements 44 are arranged between adjacent heating panels 11, 11′, 12, 12′, 13, 13′ within each row 35, 35′, 36, 36′, 37, 37′ and the further spacer elements 46 are arranged between adjacent heating panels 11, 11′, 12, 12′, 13, 13′ of adjacent rows 35, 35′, 36, 36′, 37, 37′.

Due to the spacer elements 44 and the further spacer elements 46, the heating panels 11, 11′, 12, 12′, 13, 13′ are prevented from coming too close to each other at the lateral sides 14, 16, at positions where the heating panels 11, 11′, 12, 12′, 13, 13′ are not connected to each other via the electrical connectors 28. Since the spacer elements 44 and the further spacer elements 46 are arranged at the first and second lateral sides 14, 16, the spacer elements 44 and the further spacer elements 46 do not impede the flow of fluid to be heated through the heating element 2, at least not to any substantial extent.

FIGS. 8a-8c schematically illustrates a fluid heater 50 according to embodiments. In FIG. 8a, the electric fluid heater 50 is shown in an end view i.e., a view showing an inlet end or an outlet end of the electric fluid heater 50. In FIG. 8b, a cross section of the electric fluid heater 50 along line B-B in FIG. 8a is shown. In FIG. 8c, a cross section of the electric fluid heater 50 along line C-C in FIG. 8a is shown.

The electric fluid heater 50 comprises a housing 52. The housing 52 has a fluid inlet 56 and a fluid outlet 58. A fluid flow path for the fluid to be heated is defined within the housing 52. The fluid flow path extends from the fluid inlet 56 to the fluid outlet 58. The fluid flow path is indicated with broad arrows in FIGS. 8b and 8c.

The housing 52 may be formed by a pipe or a portion of a pipe. The housing 52 may be a pressure vessel.

A heating element 2 according to any one of aspects and/or embodiments discussed herein is arranged at least part of the fluid flow path.

The heating element 2 may be arranged with its first axis 4 extending along at least part of the fluid flow path. That is the first axis 4 of the heating element 2 may extend at least in part in parallel with the fluid flow path.

According to some embodiments, such as the illustrated embodiments, the electric fluid heater 50 may comprise an insulation material 54 arranged at least along part of the fluid flow path. In this manner, the heating element 2 may be thermally and electrically insulated from the housing 52 of the electric fluid heater 50 by the insulation material 54. Also, the fluid flow path may be delimited by the insulation material 54 i.e., the insulation material 54 may define the fluid flow path within at least part of the housing 52.

The heating element 2 is easily positionable in the housing 52 due to its first and second lateral sides 14, 16 extending substantially in parallel with the first axis 4. Thus, assembly and/or maintenance of the electric fluid heater 50 is facilitated as the heating element 2 can be easily inserted into and extracted from the housing 52. The heating element 2 may be inserted into or extracted from the insulation material 54 being arranged in the housing 52. Alternatively, the heating element 2 may be inserted into or extracted from the housing 52 together with the insulation material 54.

The electric fluid heater 50 comprises three terminals 30 for connecting three phase alternating main electrical power to the heating element 2 and its heating panels.

Generally, the electric fluid heater 50 comprises the same number of terminals as the number of regions of the heating element and accordingly, the number of phases to which the heating element and the electric fluid heater are designed to be connected to. Thus, in embodiments wherein the heating element 2 is configured for connection to more than three phases, the electric fluid heater 50 comprises a corresponding number of more than three terminals.

The terminals 30 may form part of the heating element 2. Alternatively, the terminals 30 may form separate parts that are separately mounted in the electric fluid heater 50 and connected to the heating panels at respective ends of the regions of the heating element 2. A further option may be for the terminals 30 to comprise two or more components, some of such terminal components forming part of the heating element 2 and other terminal components being separately mounted in the electric fluid heater 50.

In the illustrated embodiments, the terminals 30 extend via the fluid inlet 56 and/or the fluid outlet 58 to outside the housing 52. Alternatively, the terminals 30 may extend laterally through walls of the housing 52 to outside the housing 52.

FIG. 4 illustrates a method 100 for heating a fluid in an electric fluid heater 50 according to aspects and/or embodiments discussed herein. Accordingly, in the following, reference is also made to FIGS. 1a-3d-5a)-8c.

The method 100 comprises steps of:
supplying 102 a fluid to the fluid inlet 56,
supplying 104 a three-phase electric current to the at least one heating element 2 in order to heat the fluid permeable heating panels 11, 11′, 12, 12′, 13, 13′,
conducting 106 the fluid along the fluid flow path through the fluid permeable heating panels 11, 11′, 12, 12′, 13, 13′ to the fluid outlet 58, and
leading 108 the fluid from the fluid outlet 58.

Accordingly, the fluid to be heat is supplied to the fluid inlet 56 of the electric fluid heater 50 in the step of supplying 102. The fluid may be supplied to the fluid inlet 56 via a conduit devised for conducting fluid to the electric fluid heater 50 and the fluid inlet 56.

The step of supplying 104 the three-phase electric current to the at least one heating element 2 may be performed continuously over a period of time, during which the fluid to be heated passes the electric fluid heater 50. The step of supplying 104 the three-phase electric current to the at least one heating element 2 may be started prior to or simultaneously with the step of supplying 102 fluid to the fluid inlet 56.

During the step of conducting 106 the fluid along the fluid flow path, the fluid is heated by the heating panels 11, 11′, 12, 12′, 13, 13′. The members 45 of the 3-dimensional structure of the heating panels 11, 11′, 12, 12′, 13, 13′ are heated by the electric current and the heat is transferred to the fluid as it passes through the heating panels 11, 11′, 12, 12′, 13, 13′.

In the step of leading 108 the fluid from the fluid outlet 58, the heated fluid is led to downstream use thereof, such as in a downstream process utilising the heated fluid. The fluid may be led from the fluid outlet 58 via a conduit devised for conducting the heated fluid from the electric fluid heater 50 and the fluid outlet 58.

According to embodiments, the fluid may be selected from for example but not limited to air, hydrogen, carbon dioxide, synthesis gas, pyrolysis gases, hydrocarbon, steam, and methane or a combination thereof.

In this manner, the method 100 may be utilised in a process such as e.g., preheating of process gas, and heating for catalytic reactions.

It is to be understood that the foregoing is illustrative of various example embodiments and that the invention is defined only by the appended claims. A person skilled in the art will realize that the example embodiments may be modified, and that different features of the example embodiments may be combined to create embodiments other than those described herein, without departing from the scope of the invention, as defined by the appended claims.

1. A heating element for an electric fluid heater, the heating element having an extension along a first axis and comprising a first region, a second region, and a third region, and at least three fluid permeable heating panels,
wherein each of the at least three fluid permeable heating panels comprises a 3-dimensional structure, the 3-dimensional structure comprising a multitude of members of at least one electrically conductive material,
wherein within the 3-dimensional structure, the members are connected to each other at nodes,
wherein the heating element has a 3-dimensional shape which is delimited in part by a first lateral side and an opposite second lateral side, the first and second lateral sides extending substantially in parallel with the first axis and the fluid permeable heating panels extending between the first and second lateral sides,
wherein the first region comprises a first fluid permeable heating panel of the at least three fluid permeable heating panels, the second region comprises a second fluid permeable heating panel of the at least three fluid permeable heating panels, and the third region comprises a third fluid permeable heating panel of the at least three fluid permeable heating panels,
wherein each of the first region, second region, and third region is configured to form one phase of a 3-phase electrical load, and
wherein either a common electrical conductor connects the first, second, and third regions, or a first electrical conductor, a second electrical conductor, and a third electrical conductor each connects two of the first region, the second region, and the third region.

2. The heating element according to claim 1, wherein each of the at least three fluid permeable heating panels is a result of an additive manufacturing process.

3. The heating element according to claim 1, wherein the common electrical conductor or each of the first, second, and third electrical conductors is a result of an additive manufacturing process.

4. The heating element according to claim 1, wherein the first region comprises one or more additional first fluid permeable heating panels of the at least three fluid permeable heating panels,
wherein the first fluid permeable heating panel and the one or more additional first fluid permeable heating panels are electrically connected in series via one or more electrical connectors arranged at the first and/or second lateral side,
wherein the second region comprises one or more additional second fluid permeable heating panels of the at least three fluid permeable heating panels,
wherein the second fluid permeable heating panel and the one or more additional second fluid permeable heating panels are electrically connected in series via one or more electrical connectors arranged at the first and/or second lateral side,
wherein the third region comprises one or more additional third fluid permeable heating panels of the at least three fluid permeable heating panels, and
wherein the third fluid permeable heating panel and the one or more additional third fluid permeable heating panels are electrically connected in series via one or more electrical connectors arranged at the first and/or second lateral side.

5. The heating element according to claim 4, wherein each of the one or more electrical connectors is a result of an additive manufacturing process.

6. The heating element according to claim 1, comprising at least two rows of fluid permeable heating panels arranged adjacent to each other along the first axis.

7. The heating element according to claim 4, comprising at least two rows of fluid permeable heating panels arranged adjacent to each other along the first axis,
wherein the first fluid permeable heating panel and the one or more additional first fluid permeable heating panels of the first region are arranged in a first row of the at least two rows of fluid permeable heating panels, and
wherein the second fluid permeable heating panel and the one or more additional second fluid permeable heating panels of the second region are arranged in a second row of the at least two rows of fluid permeable heating panels.

8. The heating element according to claim 4, comprising at least two rows of fluid permeable heating panels arranged adjacent to each other along the first axis,
wherein the first fluid permeable heating panel and the one or more additional first fluid permeable heating panels of the first region are arranged in a first row of fluid permeable heating panels and an additional first row of fluid permeable heating panels of the at least two rows of fluid permeable heating panels, and
wherein the second fluid permeable heating panel and the one or more additional second fluid permeable heating panels of the second region are arranged in a second row of fluid permeable heating panels and an additional second row of fluid permeable heating panels of the at least two rows of fluid permeable heating panels.

9. The heating element according to claim 8, wherein the first fluid permeable heating panel and the one or more additional first fluid permeable heating panels of the first row of fluid permeable heating panels and the additional first row of fluid permeable heating panels are electrically connected in series along an electrically conductive path via the electrical connectors being arranged at the first and second lateral sides, and
wherein some of the electrical connectors extend between adjacent fluid permeable heating panels within the first row of fluid permeable heating panels, some of the electrical connectors extend between adjacent fluid permeable heating panels within the additional first row of fluid permeable heating panels, and some of the electrical connectors extend between adjacent fluid permeable heating panels of the first row of fluid permeable heating panels and the additional first row of fluid permeable heating panels.

10. The heating element according to claim 1, comprising electrically non-conductive spacer elements arranged at the first and second lateral sides between adjacent fluid permeable heating panels.

11. The heating element according to claim 6, comprising:
electrically non-conductive spacer elements arranged at the first and second lateral sides between adjacent fluid permeable heating panels, and
at least one electrically non-conductive further spacer element arranged between fluid permeable heating panels of adjacent rows of fluid permeable heating panels of the at least two rows of fluid permeable heating panels.

12. The heating element according to claim 1, wherein a thickness of each member is within a range of 0.05-10 mm and wherein a length of each member is within a range of 0.1-50 mm.

13. The heating element according to claim 1, wherein the members are connected at the nodes to form a multitude of unit cells.

14. The heating element according to claim 1, wherein the fluid permeable heating panels are configured to be electrically heated up to a temperature of 1450 degrees Celsius, up to a temperature of 1900 degrees Celsius, or up to a temperature within a range of 1700-1900 degrees Celsius, or up to a temperature within a range of 1600-2000 degrees Celsius.

15. The heating element according to claim 4, wherein the first fluid permeable heating panel differs from one of the additional first fluid permeable heating panels by any one or a combination of the 3-dimensional structure; a cross-sectional area, thickness or width of the members; a size, shape, or number of voids within the fluid permeable heating panels; a length along the first axis of the fluid permeable heating panels.

16. The heating element according to claim 1, wherein the heating panels are designed and arranged for an energy transfer of up to 5 kW/cm³.

17. An electric fluid heater comprising a housing having a fluid inlet and a fluid outlet, wherein a fluid flow path for the fluid to be heated is defined within the housing, and wherein at least one heating element according to claim 1 is arranged along at least part of the fluid flow path.

18. The electric fluid heater according to claim 17, comprising an insulation material arranged along at least part of the fluid flow path.

19. A method for heating a fluid in an electric fluid heater (50) according to claim 17 comprising steps of:
supplying a fluid to the fluid inlet;
supplying a three-phase electric current to the at least one heating element in order to heat the fluid permeable heating panels;
conducting the fluid along the fluid flow path through the fluid permeable heating panels to the fluid outlet; and
leading the fluid from the fluid outlet.
